(19) United States
(12) Patent Application Publication
(10) Pub. No.: US 2016/0004706 A1
(43) Pub. Date: Jan. 7, 2016

(54) SECURITY TRIMMING OF SEARCH SUGGESTIONS

(71) Applicant: Microsoft Corporation, Redmond, WA (US)

(72) Inventors: Pedram Faghihi Rezaei, Seattle, WA (US); Patrick J. Baumgartner, Kirkland, WA (US); Cristian Petculescu, Seattle, WA (US); Amir Netz, Bellevue, WA (US); Chris A. Hays, Monroe, WA (US)

(21) Appl. No.: 14/321,794

(22) Filed: Jul. 1, 2014

(51) Int. Cl. G06F 17/30

(52) U.S. Cl. CPC G06F 17/3064; G06F 17/30684; G06F 17/30864

(57) ABSTRACT

Search suggestions are generated in manner that takes into account access-control information. A query can be received from a user of a search engine prior to initiating execution of the query. Data that is accessible to the user can be determined based on access information associated with the user and data. Subsequently, query suggestions can be generated dynamically based on data accessible to the user.

### BACKGROUND

Search engines are utilized to maximize the likelihood of locating relevant information amongst an abundance of data. To assist users in the process of formulating a query, most search engines include a query suggestion feature. More specifically, one or more queries are suggested based on a specified query, prior to initiating execution of a query. Often query suggestions are determined and provided in a search box as a query is entered to complete a query automatically. Current query suggestion systems present a predetermined number of query formulations to users and force users decide which one, if any, best matches their search intent. Selecting one of the query suggestions results in evaluation of the query and presentation of search results corresponding to the selected query formulation, as if the user manually typed that query into a search box.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to security trimming for search suggestions. One or more suggestions can be generated and returned in response to a query of a search engine user prior to initiating execution of the query. Moreover, suggestions can be trimmed or limited to data on one or more databases over which the query is specified and that the user is authorized to access. Additionally, query suggestions can be generated dynamically with the data accessible to the user.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of search suggestion system

FIG. 2 is a block diagram of a representative process component.

FIG. 3 is a block diagram of a representative access component.

FIG. 4 is a block diagram of a representative suggestion component.

FIG. 5 is a flow chart diagram of a method of query suggestion.

FIG. 6 is a flow chart diagram of a method of generating query suggestions.

FIG. 7 is a flow chart diagram of a method of generating related queries.

FIG. 8 is a schematic block diagram illustrating a suitable operating environment for aspects of the subject disclosure.

### DETAILED DESCRIPTION

Security on a backend database is able to prevent unauthorized access to a database. For instance, if a user attempts to access data in database by way of a query execution, no results will be returned if the user is not authorized to access the database or particular data in the database. However, it is possible that a user could effectively extract data, or otherwise learn about the existence of data, for which the user lacks access rights, through query suggestions during query formulation. By way of example, assume an employee is not authorized to have access to a company's customers stored on a database. The employee could write a query such as “What is the total number of products sold to” and pause. A suggestion could be generated to complete the query that exposes at least a subset of customers, thereby circumventing backend database security.

Details below generally pertain to security trimming of search suggestions. To facilitate query formulation, one or more suggestions can be generated and provided in response to a search query specified by a user of a search engine prior to initiating execution of the query. Moreover, suggestions can be trimmed or limited to data that the user is authorized to access to preserve security. Query suggestions can also be generated dynamically with data accessible to the user as opposed to filtering a plurality of static query suggestions based user access rights. More particularly, upon receipt of a query from a user, a determination can be made regarding what data is accessible to the user based on access information associated with the user and data. Subsequently, one or more query suggestions can be generated dynamically based on data that is accessible to the user.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

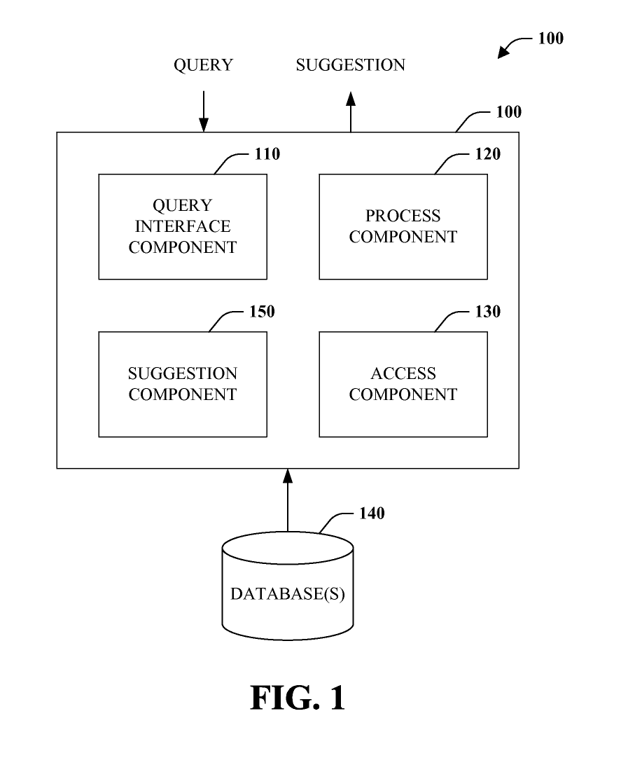

Referring initially to FIG. 1, search suggestion system 100 is illustrated. The search suggestion system 100 interacts with one or more databases 140 and includes query interface component 110, process component 120, access component 130, and suggestion component 150. The query interface component 110 is configured to receive queries from a user of a search engine, for example by way of a text box and return suggestions. In accordance with one embodiment, the query interface component 110 can be a keyword query interface configured to accept one or more keywords. In accordance with another embodiment, the query interface component 110 can be a natural language interface configured to accept user questions as opposed to keywords. As examples, a natural language search can be “What states have the lowest income tax” while the same search can be specified with keywords such as “income tax states lowest.” Going forward the description focuses on natural language queries for clarity and brevity. However, the claimed subject matter is not limited thereto.

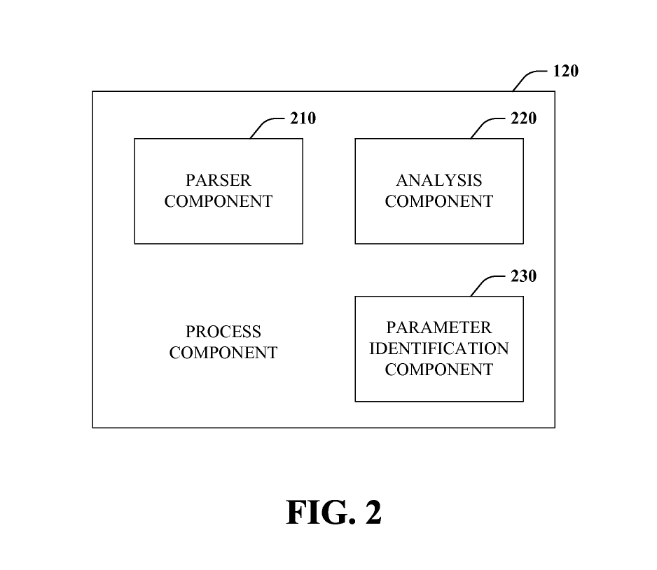

The process component 120 receives, retrieves, or otherwise obtains or acquires a query from the query interface component 110 and processes the query to determine its meaning as well as opportunities for suggestions. Turning attention briefly to FIG. 2, a representative process component 120 is depicted in further detail. The process component 120 includes parser component 210, analysis component 220, and parameter identification component 230. The parser component 210 is configured to parse a query string, identify words, and produce a representation of the query (e.g., parse tree, hierarchical structure . . . ) for further processing in accordance with known or novel parser techniques.

The analysis component 220 is configured to further processes a representation of the query produced by the parser component 210 to determine the meaning of the query. In accordance with one aspect, the analysis component can employ templates to determine meaning. A plurality of templates can be employed, wherein a template comprises a string of words or special symbols that represent a class of natural language questions or queries. The analysis component 220 can attempt to match the query to a one or more predetermined templates, for example, wherein values of the query are the same or similar to those captured by a template. Alternatively, various artificial intelligence and or statistical analysis can be employed to determine the meaning of the query.

Parameter identification component 230 is configured to identify one or more parameters of a query that are unspecified and provide an opportunity for suggestion. For example, if a template-based analysis is employed a comparison can be made between parameters of a query and those of a matching template to determine one or more parameters that are unspecified, or, in other words, template slots or gaps. Furthermore, consideration can be given to data that is available by way of one or more databases by consulting metadata associated therewith, for instance to identify the underlying structure of a database. By way of example, consider the query, or partial query, “who won a medal for.” Based on analysis of one or more matching templates, it can be determined that there is an unspecified parameter, slot, or gap after the word “for,” and based on the parameter itself and available data that parameter can be a sport, country, or continent. If the database does not include data for sports, the parameter can be associated with a country and continent.

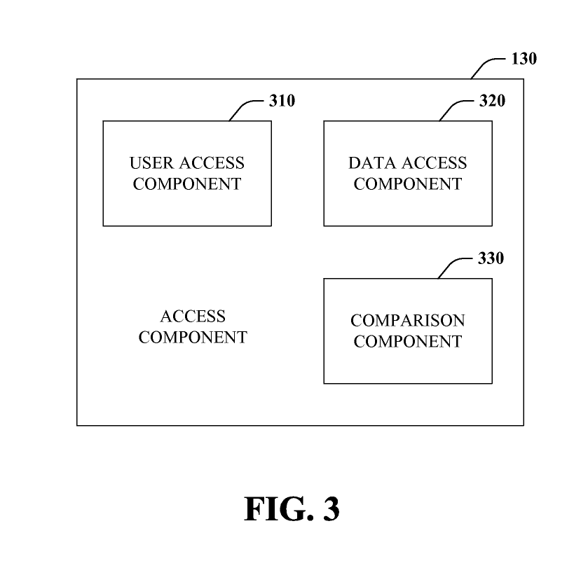

Returning to FIG. 1, the access component 130 is configured to implement access control with respect data stored in the one or more databases 140. Access information such as security context can be utilized with respect to data as well as users and employed to implement access control. Turning briefly to FIG. 3, a representative access component 130 is illustrated in further detail. User access component 310 is configured to acquire access information with respect to a search engine user. Such access information can be retrieved from an access control database or like store and include security credentials or rights. For example, a user may be required to sign in and be authenticated. Subsequently, the user's identity can be utilized to look up access information, or, in other words, the user's security context. Data access component 320 is configured to acquire access information with respect to data. For example, a database can include rules regarding rights with respect to data at various levels of granularity such as by document, row, column, or individual piece of data. The data access component 320 is configured to acquire such access information from one or more data sources. Comparison component 330 is configured to compare the rights of a user with respect to rights specified with respect to data and identify data that the user is authorized to access.

The suggestion component 150 of FIG. 1 is configured to receive or retrieve information regarding data that a user is allowed to access as determined by the access component 130 and generate query suggestions dynamically based on an input query and the data the user is allowed to access. Subsequently, these query suggestions can be provided to the user through the query interface component 110. The dynamism associated generating query suggestions is distinct from dynamism associated with a changing input query. More specifically, suggestions are generated dynamically based on a given input query. If they input query changes, for example as a user continues to type, the suggestions can change also since the query is different. These suggestions can be generated dynamically rather than looked up from previously stored static suggestions to satisfy a different query.

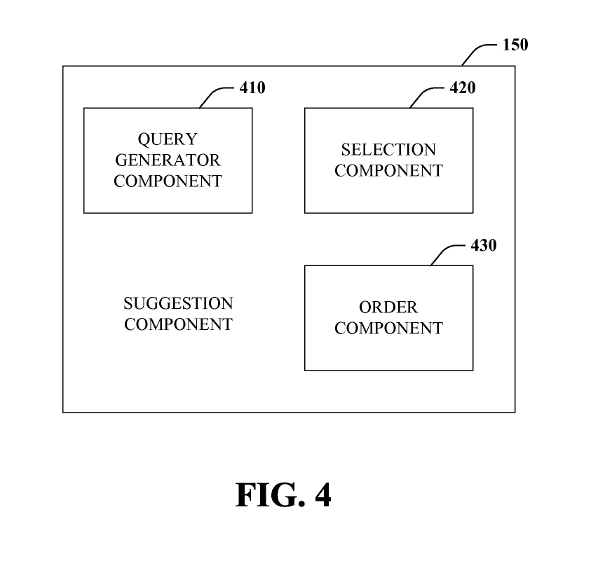

Referring to FIG. 4 a representative suggestion component 150 is illustrated in further detail. As shown, the suggestion component 150 includes query generator component 410 configured to generate a set of queries related to an input query. For example, the set of queries can include queries that complete the input query, fragments, or partial queries. Moreover, the query generator component 410 is configured to generate the set of queries based on the input query and data the user is permitted to access. Further, the set of queries can be created dynamically. For instance, one or more templates that match an input query can be utilized to generate related queries. Parameters of a template that are not specified can be assigned data the user is authorized to access. In other words, slots or gaps left in the template by the input query can be filed with data accessible to the user.

Consider again the example in which a user inputs the query or question, “who won medals for.” Based on this query and metadata from an underlying database, queries can be generated that fill in the slot after the word “for.” The slot is not going to be filled with information that is not in the underlying database. Even for data that is in the database, data can be screened to ensure it makes sense based on one or more template, for instance. Here, it can be determined sports, countries, and continents are appropriate. Accordingly, there are three templates—one for sports, one for countries, and one for continents. Now, the query generator component 410 can at least initiate interaction with a database to retrieve data from the database for sports, countries, and continents to fill these three slots in the templates and build the set of related queries from the three templates. Moreover, the templates are filled solely with data that a user is allowed to access. Consequently, if the user does not have access to sports, that template will not be used to create related queries. Further, if the user is not allowed to access countries in North America, queries will be created solely with countries outside North America, such as Germany and Spain. Stated differently, related queries are generated based on the portion of data the user is permitted to access.

The suggestion component 150 also includes selection component 420. The selection component 420 is configured to select or identify at least a subset of the related queries to present as suggestions or suggested queries. In one instance, the selection component 420 can be configured to select N″ queries, where “N” is a positive integer or in other words prune the set of related queries. For example, the selection component 420 can identify only five of the possible related queries to suggest. Further, selection can be configured to identify a top number of queries, where the top queries are more likely to be selected than other queries. Accordingly, any number of factors can be considered including, among other things, frequency of use and user context information. For instance, where metadata is available that assigns scores to data based on their frequency of use, those scores can be used as a basis to select a subset of related queries. With respect to the medal query, the sport of curling is less popular than figure skating. Accordingly, frequency of use scores associated with these two sports can reflect that fact and be utilized to select the sport of figure skating over curling. Further, user context information including preference and search history can be utilized to enable selection of queries tailored to a particular user. Furthermore, the selection component 420 can implement a diversity policy wherein a configurable amount of diversity achieved with suggestions. For instance, rather than selecting six queries that suggest sports, three suggestions can pertain to sports and three suggestions can concern countries.

Order component 430 is also provided by the suggestion component 150. The order component 430 is configured to identify an ordering of search suggestions or, stated differently, prioritize search suggestions. Accordingly, the order component 430 can receive a subset of related queries from the selection component and order the queries based on likelihood of selection by a user. To make such a determination, the order component 430 can compute scores based on frequency of user or user context such as search preferences and history. Where these scores are computed by the selection component 420 with respect to selecting a number of queries, this information can be reused for ordering. Alternatively, the order component 430 can compute such scores. Based on acquired or computed scores, the order component 430 can order search queries from most likely to be selected by a user to least likely to be selected by a user or vice versa.

Furthermore, it should be appreciated that at least a portion of functionality associated with selection such as pruning based on frequency of user and user context can be performed in combination with related query generation to focus query generation toward relevant queries and reduce the overall number of queries that are dynamically generated. For example, if a database records frequency of use information associated with data as well as access information, a threshold can be set that eliminates data that is infrequently utilized (e.g., below a threshold) from being employed in related query generation.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the analyzer component 220 can employ such mechanisms to determine the meaning of a query or question.

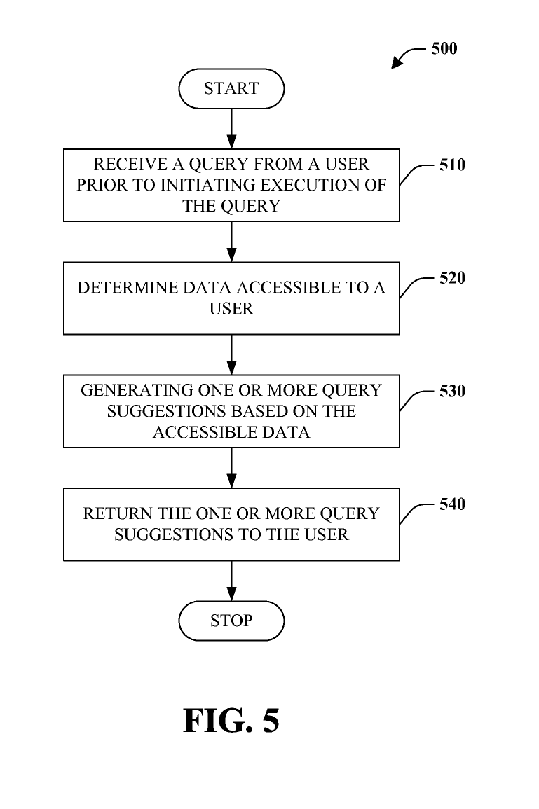

In view of the exemplary systems described above, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method 500 of query suggestion is illustrated. At numeral 510, a query is received, retrieved, or otherwise obtained or acquired from a search engine user. The query, including a query fragment or partial query, can be received from a user through a query interface, prior to initiating execution or evaluation of the query. For example, a user can specify the query in search box by typing or voice input. In accordance with one aspect, the query can be a natural language query. However, support can also be provided for a keyword search. At numeral 520, data that is accessible to the user is determined based on access information associated with the user and data. Access information can be associated with user identities. Upon authenticating a user's identity, the identity can be utilized to look up a value or set of values that define the user rights, privileges, or security level with respect to accessing data. Data itself can also include a value or set of values that define what rights or security level are required to access the data including a particular document or portion thereof (e.g., data element, row, column, group . . . ). At reference 530, one or more query suggestions are generated dynamically based on data that is accessible to the user. In one instance, query suggestions can recommend how a query can be completed. At reference numeral 540, the one or more query suggestions can be returned to a user through a query interface. For example, the one or more suggestions can be presented in a dropdown menu style below a search box. Upon selection of a query suggestion, a search can be initiated that executes or evaluates the query. Upon a change in the query, for example upon continued user specification, the method can restart at 510. In accordance with one aspect, a predetermined pause can be required to trigger suggestion, so as not to perform continuous or unnecessary computation with respect to dynamic generation of suggestions.

By way of example, consider the natural language query, “who won medals for,” specified by a query interface text box. In addition, suppose that based on security levels of the user and data, the user does not have access to medals for countries in North America. The method 500 of query suggestions can produce and return query suggestions including countries and continents outside of North America, such as “who won medals for Europe,” “who won medals for Africa,” “who won medals for Kyrgyzstan,” and “who won medals for Albania.”

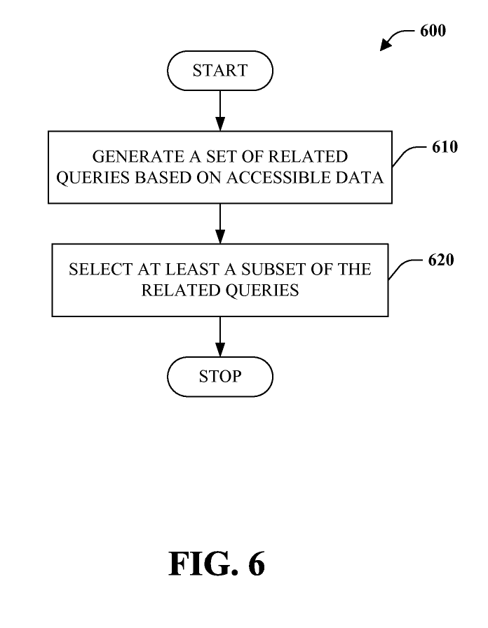

FIG. 6 is a flow chart diagram that depicts a method 600 of generating query suggestions. At reference numeral 610, a set of related queries is generated based on accessible data. More specifically, queries related to a user input query are created utilizing data that is accessible to the user based on access rights of the user and required rights of data. In the example query “who won medals for,” related queries can include queries with particular including queries including countries and continents such data is present in the database. Another set of related queries can be sports, but assuming the database does not have data regarding sports, such related queries would be excluded. Further, user access to database data is considered. Supposing the user only has rights to access countries and continents outside North America, the set of related queries is further trimmed. At reference 620, at least a subset of the set of related queries is selected as suggested queries or query suggestions. In one instance, selection is used to prune the set of related queries to a predetermined number of queries for suggestion. Such a pruning operation can employ other information and factors including, among other things, frequency of usage, user context (e.g., search preference, search history . . . ), and diversity. Furthermore, as part of the selection or another act, the selected search suggestions can be ordered or prioritized by likelihood of user selection given the query and other information. For example, values computed or obtained with respect to pruning such as frequency of use can be employed. Additional values can be generated or computed that are not used with respect to pruning but for ordering. For instance, user context can be utilized to order queries in manner custom tailored for the user.

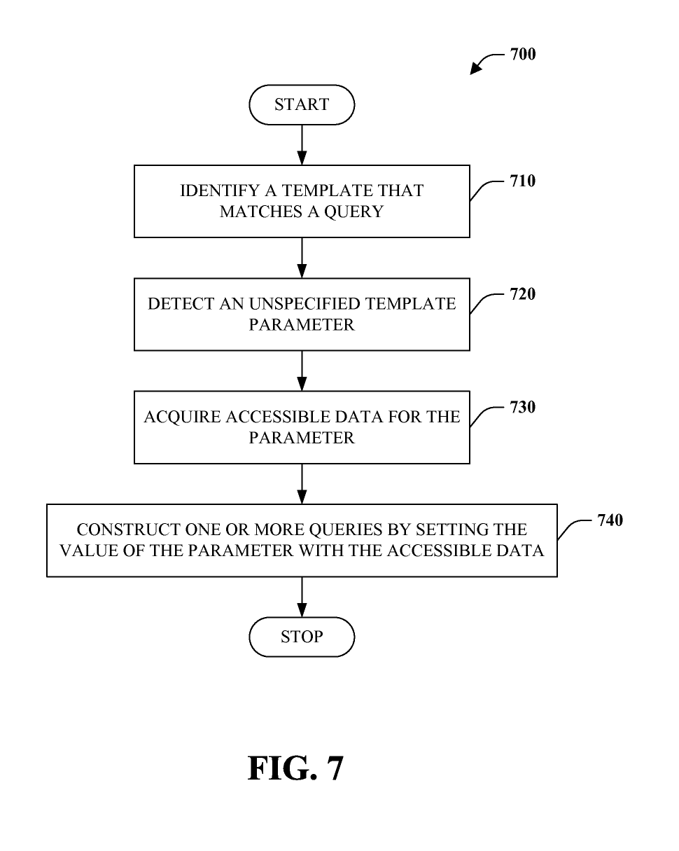

FIG. 7 illustrates a method 700 of generating related queries. At reference numeral 710, a template that matches an input query is identified. A template can be identified by matching an input query against a predetermined set of templates. A template is a string of words or special symbols that represents a class of queries. A template can include one or more parameters and values. At numeral 720, a template parameter that does not have a value specified by the input query is detected. In other words, an unspecified template parameter, gap, or slot is identified. In the example of “who won medals for,” and unspecified parameter can be detected after the word “for.” At numeral 730, data that is accessible to a particular user is acquired from the database over which the input query was specified. At reference numeral 740, one or more queries are constructed by setting or assigning the value of an unspecified parameter with the acquired data. For instance, the values “Europe,” “Africa,” and “Albania” can be acquired from the database and utilized to construct the following related queries: “who won medals for Europe,” “who won medals for Africa,” and “who won medals for Albania.”

Conventionally, search engines have provided automatic completion functionality. However, suggestions are based on what people have entered in the past. In accordance with one aspect, whether or not other users have entered a query in the past is not particularly relevant to query suggestion. What is relevant is what is known about one or more underlying databases. In other words, the subject search suggestions do not pertain to searches over arbitrary data sources but rather particular data sources. Also relevant is user rights or privileges with respect to accessing data.

Additionally, queries need not be saved to persistent storage and subsequently retrieved and filtered based on user rights. Rather, query suggestions can be generated dynamically based data accessible to a particular user. This is advantageous at least for in terms of resource utilization, namely storage. Even for a small database, potentially an infinite number of queries can be submitted. If all queries can be saved, they will occupy significant storage space. By generating query suggestions dynamically, this issue is avoided.

The subject disclosure supports various products and processes that perform, or are configured to perform, various actions regarding security trimming of search suggestions. What follows are an exemplary method, system, and computer-readable storage medium.

A method comprises employing at least one processor configured to execute computer-executable instructions stored in memory to perform the acts of receiving a query specified by a user of a search engine prior to initiating execution of the query, determining data that is accessible to the user based on access information associated with the user and the data, and generating one or more query suggestions dynamically based on the data that is accessible to the user. Generating one or more query suggestions comprises generating a set of related queries based on the data that is accessible to the user, and selecting at least a subset of the set of related queries. Selecting at least a subset of the set of related queries can also be performed based on frequency of use. Generating the set of related queries comprises identifying a template that matches the query specified by the user, detecting at least one unspecified template parameter, and constructing one or more queries by setting a value for the at least one unspecified template parameter with data that is accessible to the user. The method also comprises receiving a natural language query, ordering the one or more query suggestions based on user context, and presenting the one or more query suggestion on a display device.

A system comprises a processor coupled to a memory, the processor configured to execute the following computer-executable component stored in the memory: a first component configured to receive a query from user of a search engine prior to submission of the query to the search engine for execution, a second component configured to acquire data accessible to the user based on accessibility information associated with the user and the data, and a third component configured to dynamically generate one or more query suggestions based on the query and the data accessible by the user. In one instance, the query is a natural language question. The system can also include a fourth component configured to determine meaning of the query, which in one instance is configured to match the query to a predetermined template. The system also comprises a fifth component configured to identify an unspecified parameter by the query with respect to the template. The system additionally comprises a sixth component configured to generate a set of related queries by setting the value of the unspecified parameter with the data accessible to the user. A seventh component is configured to select a subset of the set of related queries as the one or more query suggestions. The system also comprises an eighth component configured to order the subset of the set of related queries based on context information, wherein in one instance the eighth component is configured to order the subset of the set of related queries based on frequency of use of value of the parameter set with data accessible to the user.

A computer-readable storage medium having instructions stored thereon that enable at least one processor to perform a method upon execution of the instructions, the method comprising receiving a query specified by a user of a search engine prior to initiating execution of the query, determining data that is accessible to the user based on access information associated with the user and the data, and generating one or more query suggestions dynamically based on the data that is accessible to the user. The method further comprising receiving a natural language query. Further yet, the method comprises identifying a template that matches the query specified by the user, detecting at least one template parameter unspecified by the query, and constructing one or more queries by assigning a value for the at least one unspecified template parameter with data that is accessible to the user. Still further yet, the method comprises selecting at least a subset of the one or more queries as the one or more query suggestions.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

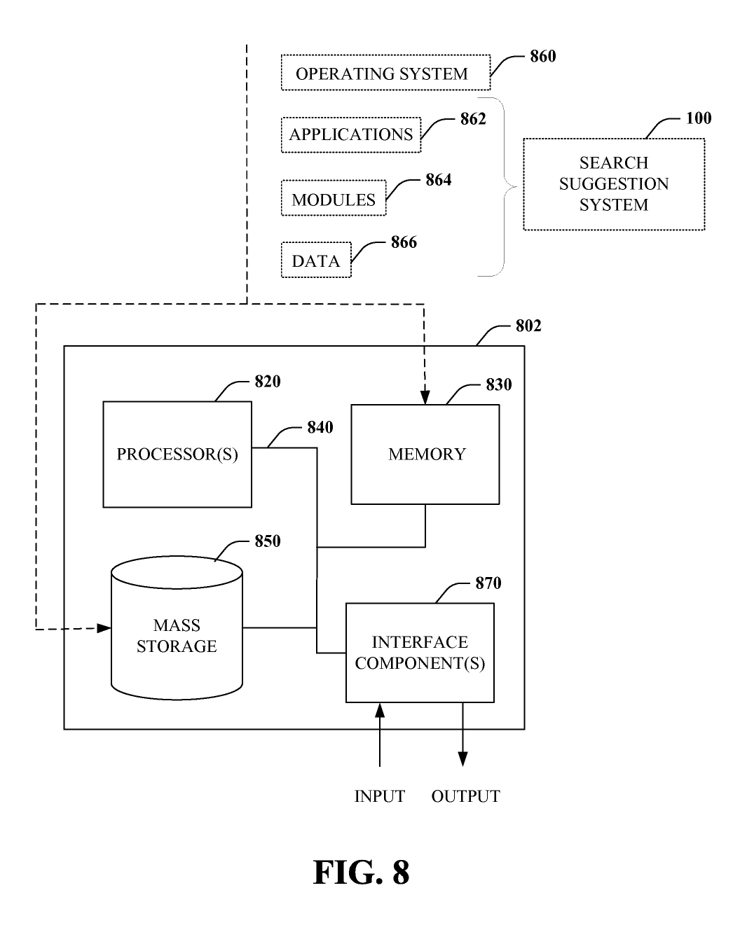

In order to provide a context for the claimed subject matter, FIG. 8 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 8, illustrated is an example general-purpose computer or computing device 802 (e.g., desktop, laptop, tablet, server, hand-held, programmable consumer or industrial electronics, set-top box, game system, compute node . . . ). The computer 802 includes one or more processor(s) 820, memory 830, system bus 840, mass storage 850, and one or more interface components 870. The system bus 840 communicatively couples at least the above system components. However, it is to be appreciated that in its simplest form the computer 802 can include one or more processors 820 coupled to memory 830 that execute various computer executable actions, instructions, and or components stored in memory 830.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 802 can include or otherwise interact with a variety of computer-readable media to facilitate control of the computer 802 to implement one or more aspects of the claimed subject matter. The computer-readable media can be any available media that can be accessed by the computer 802 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store, as opposed to transmit, the desired information accessible by the computer 802. Accordingly, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 830 and mass storage 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 802, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the memory 830. For example, mass storage 850 includes, but is not limited to, one or more devices such as a magnetic or optical disk drive, floppy disk drive, flash memory, solid-state drive, or memory stick.

Memory 830 and mass storage 850 can include, or have stored therein, operating system 860, one or more applications 862, one or more program modules 864, and data 866. The operating system 860 acts to control and allocate resources of the computer 802. Applications 862 include one or both of system and application software and can exploit management of resources by the operating system 860 through program modules 864 and data 866 stored in memory 830 and/or mass storage 850 to perform one or more actions. Accordingly, applications 862 can turn a general-purpose computer 802 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, search suggestion system 100 or portions thereof, can be, or form part, of an application 862, and include one or more modules 864 and data 866 stored in memory and/or mass storage 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the search suggestion system 100 and/or associated functionality can be embedded within hardware in a SOC architecture.

The computer 802 also includes one or more interface components 870 that are communicatively coupled to the system bus 840 and facilitate interaction with the computer 802. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 802, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., LCD, LED, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following acts:
receiving a query specified by a user of a search engine prior to initiating execution of the query;
determining data that is accessible to the user based on access information associated with the user and the data; and
generating one or more query suggestions dynamically based on the data that is accessible to the user.

2. The method of claim 1, generating one or more query suggestions comprises:
generating a set of related queries based on the data that is accessible to the user; and
selecting at least a subset of the set of related queries.

3. The method of claim 2 further comprises selecting at least a subset of the set of related queries based on frequency of use.

4. The method of claim 2 further comprises generating the set of related queries comprises:
identifying a template that matches the query specified by the user;
detecting at least one unspecified template parameter; and
constructing one or more queries by setting a value for the at least one unspecified template parameter with data that is accessible to the user.

5. The method of claim 1 further comprises receiving a natural language query.

6. The method of claim 1 further comprises ordering the one or more query suggestions based on user context.

7. The method of claim 1 further comprising presenting the one or more query suggestions on a display device.

8. A system, comprising:
a processor coupled to a memory, the processor configured to execute the following computer-executable component stored in the memory:
a first component configured to receive a query from user of a search engine prior to submission of the query to the search engine for execution;
a second component configured to acquire data accessible to the user based on accessibility information associated with the user and the data; and
a third component configured to dynamically generate one or more query suggestions based on the query and the data accessible by the user.

9. The system of claim 8, the query is a natural language question.

10. The system of claim 9 further comprises a fourth component configured to determine meaning of the query.

11. The system of claim 10, the fourth component is configured to match the query to a predetermined template.

12. The system of claim 11 further comprises a fifth component configured to identify an unspecified parameter by the query with respect to the template.

13. The system of claim 12 further comprises a sixth component configured to generate a set of related queries by setting the value of the unspecified parameter with the data accessible to the user.

14. The system of claim 13 further comprises a seventh component configured to select a subset of the set of related queries as the one or more query suggestions.

15. The system of claim 14 further comprises an eighth component configured to order the subset of the set of related queries based on context information.

16. The system of claim 15, the eighth component is configured to order the subset of the set of related queries based on frequency of use of value of the parameter set with data accessible to the user.

17. A computer-readable storage medium having instructions stored thereon that enable at least one processor to perform a method upon execution of the instructions, the method comprising:
receiving a query specified by a user of a search engine prior to initiating execution of the query;
determining data that is accessible to the user based on access information associated with the user and the data; and
generating one or more query suggestions dynamically based on the data that is accessible to the user.

18. The computer-readable storage medium of claim 17, the method further comprising receiving a natural language query.

19. The computer-readable storage medium of claim 18, the method further comprises:
identifying a template that matches the query specified by the user;
detecting at least one template parameter unspecified by the query; and
constructing one or more queries by assigning a value for the at least one unspecified template parameter with data that is accessible to the user.

20. The computer-readable storage medium of claim 19, the method further comprises selecting at least a subset of the one or more queries as the one or more query suggestions.
